(19) United States
(12) Patent Application Publication
(10) Pub. No.: US 2024/0379116 A1
(43) Pub. Date: Nov. 14, 2024

(54) AUDIO CAPTION ALIGNMENT METHOD AND APPARATUS, MEDIUM, AND ELECTRONIC DEVICE

(71) Applicant: Beijing Youzhuju Network Technology Co, Ltd., Beijing (CN)

(72) Inventors: Xiusong SUN, Beijing (CN); Zejun MA, Beijing (CN)

(21) Appl. No.: 18/662,675

(22) Filed: May 13, 2024

(30) Foreign Application Priority Data
May 11, 2023 (CN) 202310531888.0

(51) Int. Cl. G10L 21/14; G10L 25/57; H04N 21/439; H04N 21/488

(52) U.S. Cl. CPC G10L 21/14; G10L 25/57; H04N 21/4394; H04N 21/4884

(57) ABSTRACT

The disclosure relates to an audio caption alignment method and apparatus, a medium, and an electronic device. The method includes: obtaining a target audio and a target caption text of the target audio; obtaining a plurality of first target audios by slicing the target audio according to a slicing duration in a case that a duration of the target audio is greater than a first preset duration; determining first audio feature information of each of the first target audios; obtaining target audio feature information of the target audio by concatenating all of the first audio feature information in a case that the duration of the target audio is less than or equal to a second preset duration, where the second preset duration is greater than the first preset duration; and generating caption information corresponding to the target audio according to the target caption text and the target audio feature information.

### CROSS-REFERENCE TO RELATED APPLICATION(S)

This application claims priority to Chinese Application No. 202310531888.0 filed on May 11, 2023, the disclosure of which is incorporated herein by reference in the entity.

### FIELD

The disclosure relates to the technical field of audio recognition, and in particular to an audio caption alignment method and apparatus, a medium, and an electronic device.

### BACKGROUND

In an application scenario of video captions, users have the functional requirement for automatic timing. The automatic timing, also known as automatic caption alignment, refers to automatic matching a prepared caption text to audio and generating a timeline. The function is suitable for situations where both audio files and caption texts are available. In a matching process, a longer audio requires more machine resources, making the implementation of automatic timing for long audios a difficult challenge.

### SUMMARY

The summary section is provided to briefly introduce concepts, and these concepts will be described in detail in following specific implementations. The summary section is not intended to identify the key or necessary features of the technical solutions claimed for protection, nor is it intended to be used to limit the scope of the technical solutions claimed for protection.

In a first aspect, the disclosure provides a caption alignment method for an audio, comprising:
obtaining a target audio and a target caption text of the target audio;
obtaining a plurality of first target audios by slicing the target audio according to a slicing duration in a case that a duration of the target audio is greater than a first preset duration;
determining first audio feature information of each of the first target audios;
obtaining target audio feature information of the target audio by concatenating all of the first audio feature information in a case that the duration of the target audio is less than or equal to a second preset duration, where the second preset duration is greater than the first preset duration; and
generating caption information corresponding to the target audio according to the target caption text and the target audio feature information.

In a second aspect, the disclosure provides a caption alignment apparatus for an audio, including:
an obtaining module, configured to obtain a target audio and a target caption text of the target audio;
a first processing module, configured to obtain a plurality of first target audios by slicing the target audio according to a slicing duration in a case that a duration of the target audio is greater than a first preset duration;
a first determining module, configured to determine first fragment of audio feature information of each of the first target audios;
a second processing module, configured to obtain target audio feature information of the target audio by concatenating all of the first audio feature information in a case that the duration of the target audio is less than or equal to a second preset duration, where the second preset duration is greater than the first preset duration; and
a first generation module, configured to generate caption information corresponding to the target audio according to the target caption text and the target audio feature information.

In a third aspect, the disclosure provides a non-transitory computer-readable medium, having a computer program stored thereon. The program, when executed by a processing means, implements the steps of the above audio caption alignment method.

In a fourth aspect, the disclosure provides an electronic device, including:
a storage means, having a computer program stored thereon; and
a processing means, configured to execute the computer program in the storage means so as to implement the steps of the above audio caption alignment method.

Through the above technical solution, the target audio with the duration greater than the first preset duration is sliced into the plurality of first target audios, thereby determining the first audio feature information of each first target audio. If the duration of the target audio is less than or equal to the second preset duration, all of the first audio feature information is concatenated to obtain the target audio feature information of the target audio. According to the target caption text and the target audio feature information, the caption information corresponding to the target audio is generated. Accordingly, a long audio is sliced into a plurality of short audios for feature extraction of each short audio, thereby avoiding excessive occupation of machine resources. After extracting the corresponding audio feature information, if the duration of the target audio is less than or equal to the second preset duration, comprehensive target audio feature information may be formed by various audio feature information when caption alignment is performed, and a match between the target caption text and the target audio feature information is achieved through one-time alignment. Therefore, the efficiency and accuracy of feature extraction from the caption text can be effectively improved, and meanwhile the efficiency of caption alignment may also be improved to a certain degree. In combination with the target caption text, the high-accuracy caption information corresponding to the target audio can be generated, the match between the target audio and the target caption text on a timeline is achieved, and the accuracy of alignment results is improved.

Other features and advantages of the disclosure will be described in detail in the following specific implementation part.

### BRIEF DESCRIPTION OF THE DRAWINGS

The above and other features, advantages, and aspects of various embodiments of the disclosure will become more apparent in conjunction with the accompanying drawings and with reference to following specific implementations. Throughout the accompanying drawings, same or similar reference numerals denote same or similar elements. It should be understood that the accompanying drawings are illustrative, and components and elements may not necessarily be drawn to scale. In the accompanying drawings:

FIG. 1 is a flowchart of a caption alignment method for an audio according to an implementation of the disclosure;

FIG. 2 is a flowchart of a caption alignment method for an audio according to an implementation of the disclosure;

FIG. 3 is a block diagram of a caption alignment apparatus for an audio according to an implementation of the disclosure; and

FIG. 4 is a structural schematic diagram of an electronic device according to an implementation of the disclosure.

### DETAILED DESCRIPTION OF EMBODIMENTS

The embodiments of the disclosure will be described in more detail below with reference to the accompanying drawings. Although the accompanying drawings show some embodiments of the disclosure, it should be understood that the disclosure may be implemented in various forms, and should not be construed as being limited to the embodiments stated herein. On the contrary, these embodiments are provided for a more thorough and complete understanding of the disclosure. It should be understood that the accompanying drawings and the embodiments of the disclosure are for exemplary purposes only, and are not intended to limit the scope of protection of the disclosure.

It should be understood that the steps recorded in the method implementations in the disclosure may be performed in different orders and/or in parallel. In addition, the method implementations may comprise additional steps and/or omit the execution of the shown steps. The scope of the disclosure is not limited in this aspect.

The term “including” and variations thereof used in this specification are open-ended, namely “including but not limited to”. The term “based on” is interpreted as “at least partially based on”. The term “an embodiment” means “at least one embodiment”; the term “another embodiment” means “at least one additional embodiment”; and the term “some embodiments” means “at least some embodiments”. The related definitions of other terms will be provided in the subsequent description.

It should be noted that “first,” “second,” and other concepts mentioned in the disclosure are only for distinguishing different apparatuses, modules, or units, and are not intended to limit the order or relation of interdependence of functions performed by these apparatuses, modules, or units.

It should be noted that modifications of “a” and “a plurality of” mentioned in the disclosure are indicative rather than limiting, and those skilled in the art should understand that unless otherwise explicitly specified in the context, it should be interpreted as “one or more”.

The names of messages or information exchanged between a plurality of apparatuses in the implementations of the disclosure are provided for illustrative purposes only, and are not intended to limit the scope of these messages or information.

All actions of obtaining signals, information, or data in the disclosure are carried out under the premise of complying with the corresponding data protection laws and policies of the country where they are located, and are authorized by an owner of a corresponding apparatus.

It should be understood that before using the technical solutions disclosed in the embodiments of the disclosure, based on relevant laws and regulations, users should be properly informed about the types, application range, usage scenarios, etc. of personal information involved in the disclosure so as to obtain authorizations of the users.

For example, in response to receiving an active request of the user, a prompt message is sent to the user to clearly indicate the user that it is necessary to obtain and use the personal information of the user for the operation requested to be performed. Therefore, the user may freely select, according to the prompt message, whether to provide the personal information for the software or hardware such as an electronic device, an application, a server, or a storage medium executing the operations of the technical solutions of the disclosure.

As an optional but non-limiting implementation, the manner of sending the prompt message to the user in response to receiving the active request of the user may be, for example, a form of a pop-up window, and the prompt message may be represented within the pop-up window in a text form. Additionally, the pop-up window may further carry a selection control for the user to choose whether to “agree” or “disagree” to provide the personal information for the electronic device.

It should be understood that the above notification and user authorization obtaining process is only illustrative, which does not limit the implementations of the disclosure, and other methods that comply with relevant laws and regulations may also be applied to the implementations of the disclosure.

Meanwhile, it should be understood that data (including but not limited to the data itself, and data acquisition, or usage) involved in the technical solutions should comply with the requirements of corresponding laws and regulations, and relevant stipulations.

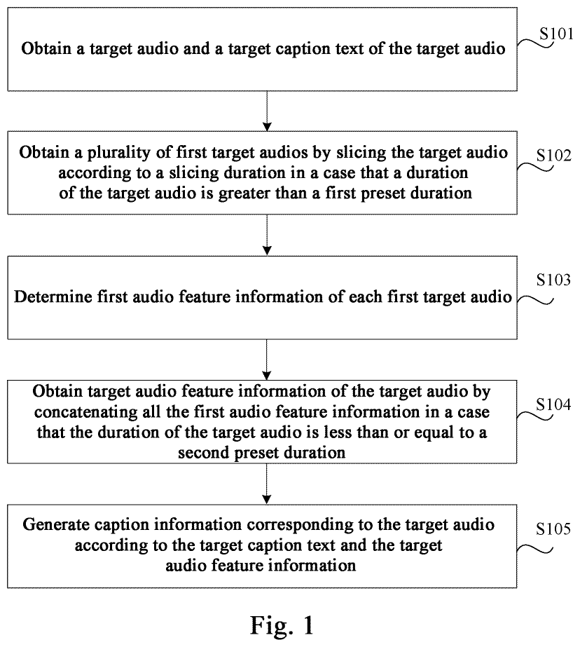

FIG. 1 is a flowchart of a caption alignment method for an audio according to an implementation of the disclosure. The method may be applied to terminals such as a smartphone, a tablet, a personal computer (PC), a laptop, and other devices, and may also be applied to a server. As shown in FIG. 1, the method may comprise S101 to S105.

S101: a target audio and a target caption text of the target audio are obtained.

Exemplarily, the target audio and the target caption text of the target audio may be uploaded by a user, and may also be obtained from a database. If a video file and a target caption text of the video file are obtained, audio data may be extracted based on the target video and converted into target audio in a standard format. The target audio is in one-to-one correspondence with the target caption text, meaning that the content expressed by the target audio and the target caption text is consistent.

S102: the target audio is sliced according to a slicing duration to obtain a plurality of first target audios in a case that the duration of the target audio is greater than a first preset duration.

S103: first audio feature information of each first target audio is determined.

Typically, based on a feature extraction model (e.g., a Transformer model), audio feature information may be extracted from audio inputted into the feature extraction model. Each first audio feature information may comprise multi-dimensional audio features, such as pitch, loudness, timbre, and other preset dimensions of audio features. However, due to an attention mechanism in the Transformer model, the Transformer model may have a poor extraction capability for audio feature information of long audio, which may affect a final alignment effect. If the duration of audio inputted into the feature extraction model is short, the extraction of the audio feature information based on the feature extraction model is accurate, and excessive machine resources may not be occupied in the audio feature information extraction process. Therefore, the target audio may be classified based on the first preset duration to determine the caption alignment method corresponding to the duration of the target audio.

The first preset duration may be preset, and for example, may be set to 5 min.

If the duration of the target audio is not greater than the first preset duration, it may be determined that the target audio is short, which allows the feature extraction model to directly extract the audio feature information from the target audio, thereby improving the accuracy of the extracted audio feature information while avoiding excessive occupation of the machine resources. Then, based on the target caption text and the extracted audio feature information, caption information corresponding to the target audio may be generated, that is, the match between the target audio and the target caption text on a timeline is achieved.

It should be noted that the caption information may not only include the caption text but also include time information corresponding to each character in the caption text.

If the duration of the target audio is greater than the first preset duration, it may be determined that the target audio is long, which allows slicing the target audio. For example, the target audio may be sliced according to a preset slicing duration. If the target audio duration is 30 minutes and the slicing duration is preset to 10 minutes, the target audio may be divided into 3 consecutive first target audios, corresponding to the content of the target audio from 0 minutes to 10 minutes, the content of the target audio from 10 minutes to 20 minutes, and the content of the target audio from 20 minutes to 30 minutes respectively. The first audio feature information of each of the above 3 consecutive first target audios may be determined through the feature extraction model. Accordingly, the accuracy of the determined first audio feature information of the first target audio may be improved, thereby enhancing the accuracy of the obtained target audio feature information of the target audio. Meanwhile, in the process of determining feature information of a first segment of audio of each first target audio, excessive occupation of the machine resources can be avoided, the feature extraction model is prevented from running beyond the capacity, and an application range of the feature extraction model is enlarged.

S104: all of the first audio feature information is concatenated to obtain target audio feature information of the target audio in a case that the duration of the target audio is less than or equal to a second preset duration.

The second preset duration is greater than the first preset duration. The second preset duration may be predetermined based on an upper limit of an optimal duration corresponding to an alignment model that can achieve forced alignment between the target caption text and the target audio feature information. For example, in a process of training the alignment model, an optimal duration range of audio that the alignment model can process can be determined based on a confidence of alignment information corresponding to training data (sample audio and a text corresponding to the sample audio) of different durations. For example, the upper limit of the optimal duration can be determined based on the audio duration range corresponding to training data where the confidence of the alignment information is higher than a first threshold, and is determined as the second preset duration. For example, the second preset duration may be set to 20 min.

If the duration of the target audio is less than or equal to the second preset duration, it may be determined that the alignment model can achieve a match between the target caption text and the target audio feature information through one-time alignment. Compared with concatenating a plurality of alignment information, the accuracy of alignment results can be effectively improved, that is, caption information with higher accuracy is generated. All of the first audio feature information may be concatenated to obtain the target audio feature information of the target audio. When the target audio is sliced, each first target audio may have time information corresponding to the target audio. The first audio feature information may be concatenated based on the sequence of time information corresponding to each first target audio.

Continuing from the above, the target audio is sliced into the 3 consecutive first target audios. If the first audio feature information obtained from the first target audio corresponding to the target audio of 0 minutes to 10 minutes through the feature extraction model is denoted as ctc_logits1, the first audio feature information obtained from the first target audio corresponding to the target audio of 10 minutes to 20 minutes through the feature extraction model is denoted as ctc_logits2, and the first audio feature information obtained from the first target audio corresponding to the target audio of 20 minutes to 30 minutes through the feature extraction model is denoted as ctc_logits3, the target audio feature information obtained through concatenation may be [ctc_logit1, ctc_logit2, ctc_logit3]. For example, the audio feature information extracted by the feature extraction model may be frame-level audio feature information, and the corresponding alignment model may output frame-level alignment information, with each frame of 40 ms. Therefore, an audio representation corresponding to the first audio feature information may be denoted as [slice duration*60*1000/40, the number of dimensions], and an audio representation corresponding to the target audio feature information may be denoted as [target audio duration*60*1000/40, the number of dimensions]. The alignment information includes the frame of audio and characters in the target caption text matching the frame of audio.

S105: caption information corresponding to the target audio is generated according to the target caption text and the target audio feature information.

Exemplarily, the caption information corresponding to the target audio may be generated through output information of the alignment model as described above, that is, the match between the target audio and the target caption text on the timeline is achieved. The alignment model may be modeled based on a forced alignment algorithm in the related technologies, and is trained in a machine learning method, using sample audio provided by an open source database and a text corresponding to the sample audio as a training sample. Specifically, the target caption text and the target audio feature information may be inputted into a pre-trained alignment model, and an obtained model output result is alignment information for the target caption text and the target audio feature information. The alignment model may be, for example, stored locally, and called locally each time the alignment model is used, or may be stored on a third-party platform and called from a third party each time the alignment model is used. No specific limitations are imposed here. The alignment information outputted by the alignment model may be frame-level alignment information. Based on the frame-level alignment information, time-level alignment information may be determined to generate caption information corresponding to the target audio.

Through the above technical solution, the target audio with the duration greater than the first preset duration is sliced into the plurality of first target audios, thereby determining the first audio feature information of each first target audio. If the duration of the target audio is less than or equal to the second preset duration, all of the first audio feature information is concatenated to obtain the target audio feature information of the target audio. According to the target caption text and the target audio feature information, the caption information corresponding to the target audio is generated. Accordingly, the long audio is sliced into the plurality of short audios for feature extraction of each short audio, thereby avoiding the excessive occupation of the machine resources. After extracting the corresponding audio feature information, if the duration of the target audio is less than or equal to the second preset duration, comprehensive target audio feature information may be formed by various audio feature information when caption alignment is performed, and the match between the target caption text and the target audio feature information is achieved through one-time alignment. Therefore, the efficiency and accuracy of feature extraction from the caption text can be effectively improved, and meanwhile the efficiency of caption alignment may also be improved to a certain degree. In combination with the target caption text, the high-accuracy caption information corresponding to the target audio can be generated, the match between the target audio and the target caption text on the timeline is achieved, and the accuracy of the alignment results is improved.

Optionally, in S103, the step of determining first segment of audio feature information of each first target audio may comprise:
the first target audio is inputted into a pre-trained feature extraction model to obtain the audio feature information of the first target audio.

The feature extraction model may be an encoder in a model trained based on sample audio and a text corresponding to the sample audio. It should be noted that the feature extraction model is a machine learning model obtained through the machine learning method, which can extract the audio feature information. After model training is completed, the encoder in the model may be used as the feature extraction model. The feature extraction model may be, for example, stored locally, and called locally each time the feature extraction model is used, or may be stored on the third-party platform and called from the third party each time the feature extraction model is used. No specific limitations are imposed here. The audio feature information extracted by the feature extraction model may be frame-level audio feature information.

Optionally, in S105, the step of generating caption information corresponding to the target audio based on the target caption text and the target audio feature information may comprise:
alignment information of each frame of audio in the target audio is determined according to the target caption text and the target audio feature information, where the alignment information includes the frame of audio and characters in the target caption text matching the frame of audio.

The caption information corresponding to the target audio is generated according to the alignment information and frame length of each frame of audio.

Exemplarily, if it is determined, based on the above alignment model, that a second frame of audio in the target audio and a first character in the target caption text form a set of alignment information, a third frame of audio in the target audio and the first character in the target caption text form a set of alignment information, a fourth frame of audio in the target audio and a second character in the target caption text form a set of alignment information, the frame length of the audio is 40 ms, and therefore the duration corresponding to the first character in the target caption text on the timeline is 80 ms. The start time is the start time of the second frame of audio, and the end time is the end time of a third audio frame, that is, the first character corresponds to the target audio from 40 ms to 120 ms. Accordingly, based on the frame-level alignment information, the time-level alignment information can be determined, thereby achieving a match between the target audio and the target caption text on the timeline.

Due to diverse usage scenarios of the user, the duration of the audio may exceed the second preset duration. However, the amount of data that the alignment model can process each time is limited, making it difficult to achieve caption alignment for ultra-long audio through one-time alignment. Even if the alignment model can operate beyond the capacity, the accuracy of output results is not ideal. Therefore, the disclosure further provides the following embodiments to solve the problem.

In an optional embodiment, the audio caption alignment method provided in the disclosure may further comprise:

a caption text segment corresponding to each first target audio is determined based on the first audio feature information and the target caption text; alignment information of each frame of audio in each first target audio is determined based on the first audio feature information and the caption text segment; and the alignment information of each first target audio is concatenated to generate caption information corresponding to the target audio.

Exemplarily, for each first target audio, the caption text segment corresponding to the first target audio may be determined from the target caption text based on a minimum editing distance algorithm in the related technologies, the first audio feature information, and the target caption text.

The first audio feature information and the caption text segment of the first target audio may be inputted into the above alignment model to obtain the alignment information of each frame of audio in the first target audio. Therefore, after determining the alignment information of each frame of audio in each first target audio, the alignment information of each frame of audio in each first target audio may be temporally concatenated according to the time information of each first target audio to generate caption information corresponding to the target audio.

Accordingly, the amount of data corresponding to each first audio feature information may be adapted to the alignment model, such that the amount of data processed by the alignment model each time is within an allowable range to output accurate alignment information.

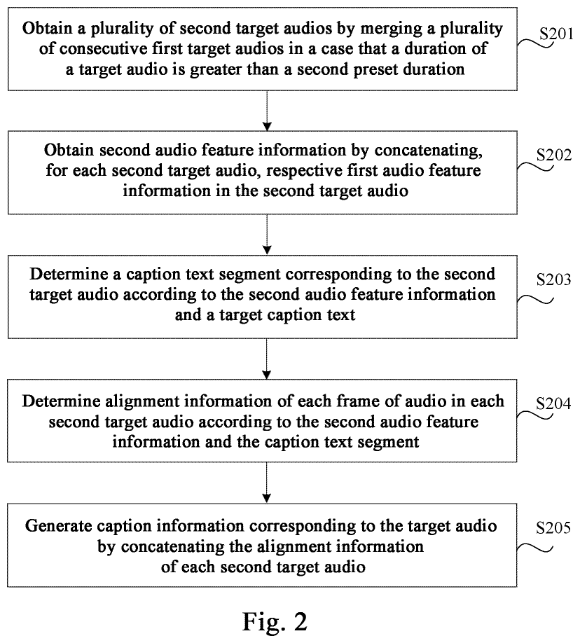

In another optional embodiment, the audio caption alignment method provided in the disclosure may be illustrated in FIG. 2. FIG. 2 is a flowchart of a caption alignment method for an audio according to an implementation of the disclosure. As shown in FIG. 2, the method may comprise S201 to S205.

S201: a plurality of consecutive first target audios are merged to obtain a plurality of second target audios in a case that the duration of a target audio is greater than a second preset duration.

The duration of each second target audio does not exceed the second preset duration.

S202: For each second target audio, various first audio feature information in the second target audio is concatenated to obtain second audio feature information.

Exemplarily, if the duration of the target audio is 60 minutes and the slice duration is preset to 10 minutes, 6 consecutive first target audios may be obtained, respectively corresponding to the content of the target audio from 0 minutes to 10 minutes, the content of the target audio from 10 minutes to 20 minutes, the content of the target audio from 20 minutes to 30 minutes, the content of the target audio from 30 minutes to 40 minutes, the content of the target audio from 40 minutes to 50 minutes, and the content of the target audio from 50 minutes to 60 minutes. The first audio feature information of the 6 consecutive first target audios is sequentially ctc_logit1, ctc_logit2, ctc_logit3, ctc_logit4, ctc_logit5, and ctc_logit6.

The plurality of consecutive first target audios are merged to obtain the plurality of second target audios. Using the example that 3 consecutive second target audios are obtained within the second preset duration of 20 minutes, the 3 consecutive second target audios respectively correspond to the content of the target audio from 0 minutes to 20 minutes, the content of the target audio from 20 minutes to 40 minutes, and the content of the target audio from 40 minutes to 60 min. Second audio feature information of the 3 consecutive second target audios is sequentially ctc_logit1+ctc_logit2, ctc_logit3+ctc_logit4, and ctc_logit5+ctc_logit6.

Accordingly, by concatenating the various first audio feature information in the second target audio, the amount of data corresponding to each obtained second audio feature information may be adapted to the alignment model, thereby reducing the number of times of alignment while ensuring that the amount of data processed by the alignment model each time is within the allowable range so as to output accurate alignment information.

S203: a caption text segment corresponding to the second target audio is determined according to the second audio feature information and the target caption text.

Exemplarily, the caption text segment corresponding to the second target audio may be determined from the target caption text based on the minimum editing distance algorithm, the second audio feature information, and the target caption text. The duration of the target audio being greater than the second preset duration indicates that the target audio is long, and the corresponding content in the target caption text is similarly extensive. Since the second target audio is a part of the target audio, the caption text segment corresponding to the second target audio is also a part of the target caption text. For example, the target caption text may comprise 3000 characters, and using the example that the second target audio corresponds to the content of the target audio from 20 minutes to 40 minutes, if it is determined that the second target audio corresponds to characters 800 to 1700 in the target caption text through the minimum editing distance algorithm, the characters 800 to 1700 in the target caption text may be determined as the caption text segment corresponding to the second target audio.

S204: alignment information of each frame of audio in each second target audio is determined according to the second audio feature information and the caption text segment.

Exemplarily, the alignment information of each frame of audio in each second target audio may be sequentially determined through the above alignment model. The alignment information may comprise the frame of audio and characters in the frame of audio matching the target caption text.

S205: the alignment information of each second target audio is concatenated to generate caption information corresponding to the target audio.

For example, the second target audio corresponding to the target audio from 0 minute to 20 minutes corresponds to characters 1 to 799 in the target caption text, and alignment information of the second target audio may be obtained based on the alignment model; the second target audio corresponding to the target audio from 20 minutes to 40 minutes corresponds to characters 800 to 1700 in the target caption text, and alignment information of the second target audio may be obtained based on the alignment model; and the second target audio corresponding to the target audio from 40 minutes to 60 minutes corresponds to characters 1701 to 300 in the target caption text, and alignment information of the second target audio may be obtained based on the alignment model. The alignment information of the 3 second target audios may be concatenated based on the sequence of time information corresponding to the above 3 second target audios and the target audio. Therefore, the concatenated audio is the same as the target audio, and the concatenated caption may be the same as the target caption text. By concatenating the alignment information according to time, a complete match between the target audio and the target caption text on the timeline can be achieved, that is, the caption information corresponding to the target audio is generated.

In the process of determining the caption text segment corresponding to the second target audio based on the minimum editing distance algorithm, the accuracy of the determined caption text segment may be insufficient due to the problems such as insufficient precision of the algorithm. Therefore, after the determined caption text segments are concatenated to obtain a concatenated caption text, differences between the concatenated caption text and the target caption text are found during comparison. The problems such as repeated text segments or missing text segments, etc. may exist in the concatenated caption text. Therefore, by merging the plurality of consecutive first target audios, the amount of data processed by the alignment model each time is within the allowable range, thereby outputting the accurate alignment information, and reducing the number of second target audios to be concatenated in the concatenation process of the alignment information so as to reduce the occurrence possibility of the above problems and improve the accuracy of alignment results.

To further solve the above problems, after concatenating the alignment information of each second target audio to generate the caption information corresponding to the target audio, the audio caption alignment method provided in the disclosure may further comprise:
the concatenated caption text in the caption information is compared with the target caption text to determine whether a missing text exists; and
a first caption text segment and a second caption text segment adjacent to the missing text are determined according to the target caption text if the missing text exists, where time information corresponding to the first caption text segment is earlier than time information corresponding to the second caption text segment.

A text insertion time is determined based on a last moment in the alignment information corresponding to the first caption text segment and an earliest moment in the alignment information corresponding to the second caption text segment; and
the missing text is inserted into the concatenated caption text within the text insertion time to obtain updated caption information.

Exemplarily, the second target audio corresponding to the target audio from 0 minute to 20 minutes corresponds to characters 1 to 790 in the target caption text; and the second target audio corresponding to the target audio from 20 minutes to 40 minutes corresponds to characters 800 to 1700 in the target caption text. Accordingly, by comparing the determined concatenated caption text in the caption information and the target caption text, characters 791 to 799 are missing, that is, the characters 791 to 799 are the missing text. Based on the time information of the caption text segments, the characters 1 to 790 may be determined as a first caption text segment, and the characters 800 to 1700 may be determined as a second caption text segment. If the last moment in the alignment information corresponding to the first caption text segment is 19 minute 58 seconds, and the earliest moment in the alignment information corresponding to the second caption text segment is 20 minutes 07 seconds, with a difference of 9 seconds between the two, and then the characters 791 to 799 are inserted within 9 seconds. For example, each character of the missing text may occupy the same duration within the text insertion time, that is, the 1st second within 9 seconds corresponds to the character 791, the 2nd second corresponds to the character 792, and so on. Accordingly, by directly inserting the missing text within the text insertion time to obtain the updated caption information, the caption text in the finally obtained caption information can be made consistent with the target caption text, and the impact on the alignment information corresponding to other characters can be avoided.

To further solve the above problems, after concatenating the alignment information of each second target audio to generate the caption information corresponding to the target audio, the audio caption alignment method provided in the disclosure may further comprise:
if determining, based on the target caption text, there is a repeated text in the alignment information corresponding to adjacent second target audios, a confidence of the repeated text in the adjacent second target audios are respectively determined; and
in the adjacent second target audios, the repeated text in the alignment information of the second target audio with a low confidence is removed to obtain updated caption information.

The step that a confidence of the repeated text in the adjacent second target audios are respectively determined may comprise:
a matching confidence of each character of the repeated text in the two adjacent second target audios is respectively determined.

The confidence of the repeated text in the second target audio is determined according to the matching confidence of each character in the second target audio.

Exemplarily, if two adjacent caption text segments are concatenated and there is a repeated character segment at the end of the previous caption text segment and the beginning of the next caption text segment, and the character segment appears once at a corresponding position of the target caption text, and then the repeated character segment may be determined as a repeated text. The second target audio corresponding to the target audio from 0 minute to 20 minutes corresponds to characters 1 to 810 in the target caption text; and the second target audio corresponding to the target audio from 20 minutes to 40 minutes corresponds to characters 800 to 1700 in the target caption text. Accordingly, by comparing the determined concatenated caption text in the caption information and the target caption text, characters 800 to 810 appear simultaneously in the caption text segments of the two adjacent second target audios, that is, the characters 800 to 810 are the repeated text. Consistency between the caption text in the finally obtained caption information and the target caption text is ensured.

As an example, the repeated text may be removed from the caption text segment of the second target audio corresponding to the target audio from 0 minute to 20 minutes, or the caption text segment of the second target audio corresponding to the target audio from 20 minutes to 40 min.

As another example, when outputting the frame-level alignment information, the alignment model may also output the confidence of that alignment information. Accordingly, based on the confidence of the alignment information of each frame of audio, the matching confidence of each character of the repeated text in the two adjacent second target audios can be respectively determined. For each second target audio, the average of the matching confidence of all of the characters in the repeated text in the second target audio may be determined as the confidence of the repeated text in the second target audio. In the adjacent second target audios, the repeated text in the alignment information of the second target audio with a low confidence may be removed to obtain updated caption information. For example, if the confidence of the repeated text in the second target audio corresponding to the target audio from 0 minute to 20 minutes is low, the text content of the characters 800 to 810 in the alignment information of the second target audio may be removed. If the characters 800 to 810 in the second target audio corresponding to the target audio from 0 minute to 20 minutes corresponds to the time from 19 minutes 20 seconds to 20 minutes, and the characters 800 to 810 in the second target audio corresponding to the target audio from 20 minutes to 40 minutes correspond to the time from 21 minutes to 21 minutes 50 seconds, after removing the repeated text, the audio from 19 minutes 20 seconds to 20 minutes has no corresponding caption, and the audio from 21 minutes to 21 minutes 50 seconds corresponds to the characters 800 to 810. Accordingly, the caption text in the finally obtained caption information can be made consistent with the target caption text, and the accuracy of the caption information is improved as much as possible while avoiding the impact on the alignment information corresponding to other characters.

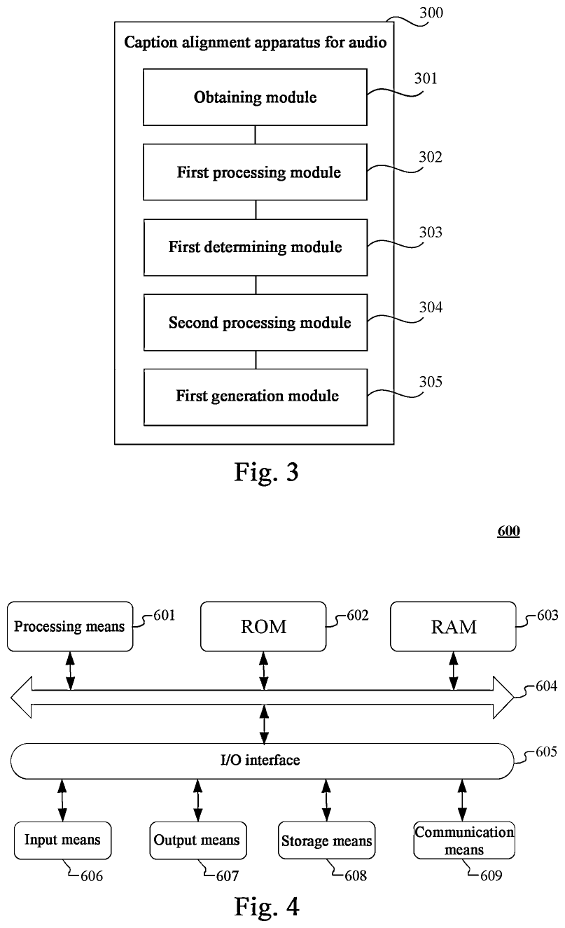

Based on the same inventive concept, the disclosure further provides a caption alignment apparatus for an audio. FIG. 3 is a block diagram of a caption alignment apparatus for an audio according to an implementation of the disclosure. As shown in FIG. 3, the audio caption alignment apparatus 300 may comprise:
an obtaining module 301, configured to obtain a target audio and a target caption text of the target audio;
a first processing module 302, configured to obtain a plurality of first target audios by slicing the target audio according to a slicing duration in a case that a duration of the target audio is greater than a first preset duration;
a first determining module 303, configured to determine first audio feature information of each of the first target audios;
a second processing module 304, configured to obtain target audio feature information of the target audio by concatenating all of the first audio feature information in a case that the duration of the target audio is less than or equal to a second preset duration, where the second preset duration is greater than the first preset duration; and
a first generation module 305, configured to generate caption information corresponding to the target audio according to the target caption text and the target audio feature information.

Through the above technical solution, the target audio with the duration greater than the first preset duration is sliced into the plurality of first target audios, thereby determining the first audio feature information of each first target audio. If the duration of the target audio is less than or equal to the second preset duration, all of the first audio feature information is concatenated to obtain the target audio feature information of the target audio. According to the target caption text and the target audio feature information, the caption information corresponding to the target audio is generated. Accordingly, a long audio is sliced into a plurality of short audios for feature extraction of each short audio, thereby avoiding excessive occupation of machine resources. After extracting the corresponding audio feature information, if the duration of the target audio is less than or equal to the second preset duration, comprehensive target audio feature information may be formed by various audio feature information when caption alignment is performed, and a match between the target caption text and the target audio feature information is achieved through one-time alignment. Therefore, the efficiency and accuracy of feature extraction from the caption text can be effectively improved, and meanwhile the efficiency of caption alignment may also be improved to a certain degree. In combination with the target caption text, the high-accuracy caption information corresponding to the target audio can be generated, the match between the target audio and the target caption text on a timeline is achieved, and the accuracy of alignment results is improved.

Optionally, the apparatus 300 further comprises:
a third processing module, configured to obtain a plurality of second target audios by merging a plurality of the consecutive first target audios in a case that the duration of the target audio is greater than the second preset duration, where the duration of each of the second target audios does not exceed the second preset duration;
a fourth processing module, configured to obtain second audio feature information by concatenating, for each of the second target audios, respective first audio feature information in the second target audio;
a second determining module, configured to determine a caption text segment corresponding to the second target audio according to the second audio feature information and the target caption text;
a third determining module, configured to determine alignment information of each frame of audio in each of the second target audios according to the second audio feature information and the caption text segment, where the alignment information includes the frame of audio and characters in the target caption text matching the frame of audio; and
a second generation module, configured to generate caption information corresponding to the target audio by concatenating the alignment information of each of the second target audios.

Optionally, the apparatus 300 further comprises:
a comparison module, configured to compare a concatenated caption text in the caption information with the target caption text to determine whether a missing text exists;
a fourth determining module, configured to determine a first caption text segment and a second caption text segment adjacent to the missing text according to the target caption text if the missing text exists, where time information corresponding to the first caption text segment is earlier than time information corresponding to the second caption text segment;
a fifth determining module, configured to determine a text insertion time based on a last moment in the alignment information corresponding to the first caption text segment and an earliest moment in the alignment information corresponding to the second caption text segment; and
a first update module, configured to insert the missing text into the concatenated caption text within the text insertion time to obtain updated caption information.

Optionally, the apparatus 300 further comprises:
a sixth determining module, configured to respectively determine, in the case of determining, based on the target caption text, there is a repeated text in the alignment information corresponding to the adjacent second target audios, a confidence of the repeated text in the adjacent second target audios; and
a second update module, configured to remove the repeated text in the alignment information of the second target audio with a low confidence from the adjacent second target audios to obtain updated caption information.

Optionally, the sixth determining module is configured to respectively determine the confidence of the repeated text in the adjacent second target audios by:
determining a matching confidence of each character of the repeated text in the two adjacent second target audios respectively; and
determining a confidence of the repeated text in the second target audio according to the matching confidence of each of the characters in the second target audio.

Optionally, the first determining module 303 is configured to determine first segment of audio feature information of each of the first target audios comprises:
inputting the first target audio into a pre-trained feature extraction model to obtain audio feature information of the first target audio, where the feature extraction model is an encoder in a model trained based on sample audio and a text corresponding to the sample audio.

Optionally, the second processing module 304 comprises:
a first determining submodule, configured to determine alignment information of each frame of audio in the target audio according to the target caption text and the target audio feature information, where the alignment information includes the frame of audio and characters in the target caption text matching the frame of audio; and
a generation submodule, configured to generate caption information corresponding to the target audio according to the alignment information and frame length of each frame of audio.

Referring to FIG. 4 below, FIG. 4 illustrates a structural schematic diagram of an electronic device 600 suitable for implementing embodiments of the disclosure. The terminal device in this embodiment of the disclosure may comprise, but is not limited to, mobile terminals such as a mobile phone, a notebook computer, a digital radio receiver, a personal digital assistant (PDA), a portable Android device (PAD), a portable media player (PMP), and a vehicle-mounted terminal (e.g., a vehicle-mounted navigation terminal), and fixed terminals such as a digital TV and a desk computer. The electronic device shown in FIG. 4 is merely an example, which should not impose any limitations on functions and application ranges of the embodiments of the disclosure.

As shown in FIG. 4, the electronic device 600 may comprise a processing means (e.g., a central processing unit and a graphics processing unit) 601, which may perform various appropriate actions and processing according to programs stored on a read-only memory (ROM) 602 or loaded from a storage means 608 into a random access memory (RAM) 603. The RAM 603 further stores various programs and data required for the operation of the electronic device 600. The processing means 601, the ROM 602, and the RAM 603 are connected to one another through a bus 604. An input/output (I/O) interface 605 is also connected to the bus 604.

Typically, the following apparatuses may be connected to the I/O interface 605: an input means 606, including, for example, a touchscreen, a touchpad, a keyboard, a mouse, a camera, a microphone, an accelerometer, and a gyroscope; an output means 607, including, for example, a liquid crystal display (LCD), a speaker, and a vibrator; the storage means 608, including, for example, a magnetic tape and a hard drive; and a communication means 609. The communication means 609 may allow the electronic device 600 to be in wireless or wired communication with other devices for data exchange. Although FIG. 4 illustrates the electronic device 600 with various apparatuses, it should be understood that it is not necessary to implement or have all of the shown apparatuses. Alternatively, more or fewer apparatuses may be implemented or provided.

Particularly, the foregoing process described with reference to the flowcharts according to the embodiments of the disclosure may be implemented as a computer software program. For example, an embodiment of the disclosure includes a computer program product including a computer program carried on a non-transitory computer-readable medium. The computer program includes program code for performing the method shown in the flowchart. In this embodiment, the computer program may be downloaded and installed from the network through the communication means 609, or installed from the storage means 608, or installed from the ROM 602. The computer program, when executed by the processing means 601, performs the above functions limited in the method in the embodiments of the disclosure.

It should be noted that the computer-readable medium in the disclosure may be a computer-readable signal medium, or a computer-readable storage medium, or any combination of the above. For example, the computer-readable storage medium may comprise, but is not limited to: electrical, magnetic, optical, electromagnetic, infrared, or semiconductor systems, apparatuses, or devices, or any combination of the above. More specific examples of the computer-readable storage medium may comprise, but are not limited to: an electrical connection with one or more wires, a portable computer disk, a hard drive, a random access memory (RAM), a read-only memory (ROM), an erasable programmable read-only memory (EPROM or a flash), fiber optics, a portable compact disc read-only memory (CD-ROM), an optical storage device, a magnetic storage device, or any proper combination of the above. In the disclosure, the computer-readable storage medium may be any tangible medium including or storing a program, and the program may be used by an instruction execution system, apparatus, or device, or used in conjunction with the instruction execution system, apparatus, or device. However, in the disclosure, the computer-readable signal medium may comprise data signals propagated in a baseband or propagated as a part of a carrier wave, which carry computer-readable program code. The propagated data signals may have a plurality of forms, including but not limited to electromagnetic signals, optical signals, or any proper combination of the above. The computer-readable signal medium may also be any computer-readable medium other than the computer-readable storage medium. The computer-readable signal medium may send, propagate, or transmit the program used by the instruction execution system, apparatus, or device, or used in conjunction with the instruction execution system, apparatus, or device. The program code included in the computer-readable medium may be transmitted by any proper medium including but not limited to a wire, an optical cable, radio frequency (RF), etc., or any proper combination of the above.

In some implementations, the client and the server can communicate using any currently known or future-developed network protocols such as a hypertext transfer protocol (HTTP), and may also be can be in communication connection with digital data in any form or medium (e.g., a communication network). Examples of the communication network include a local area network (“LAN”), a wide area network (“WAN”), Internet work (e.g., Internet), a peer-to-peer network (e.g., an ad hoc peer-to-peer network), and any currently known or future-developed networks.

The computer-readable medium may be included in the above electronic device; and may separately exist without being assembled in the electronic device.

The computer-readable medium carries one or more programs. The one or more programs, when executed by the electronic device, enable the electronic device to:
obtain a target audio and a target caption text of the target audio;
obtain a plurality of first target audios by slicing the target audio according to a slicing duration in a case that a duration of the target audio is greater than a first preset duration;
determine first audio feature information of each of the first target audios;
obtain target audio feature information of the target audio by concatenating all of the first audio feature information in a case that the duration of the target audio is less than or equal to a second preset duration, where the second preset duration is greater than the first preset duration; and
generate caption information corresponding to the target audio according to the target caption text and the target audio feature information.

Computer program code for performing the operations of the disclosure may be written in one or more programming languages or a combination thereof. The programming languages include, but are not limited to, object-oriented programming languages such as Java, Smalltalk, C++, as well as conventional procedural programming languages such as “C” or similar programming languages. The program code may be executed entirely on a user computer, partly on the user computer, as a stand-alone software package, partly on the user computer and partly on a remote computer, or entirely on a remote computer or the server. In the case of involving the remote computer, the remote computer may be connected to the user computer through any type of network, including a local area network (LAN) or wide area network (WAN), or may be connected to an external computer (e.g., utilizing an Internet service provider for Internet connectivity).

The flowcharts and block diagrams in the accompanying drawings illustrate system architectures, functions, and operations possibly implemented by the system, method and computer program product according to the various embodiments of the disclosure. In this regard, each block in the flowcharts or block diagrams may represent a module, a program segment, or a portion of code, and the module, program segment, or portion of code includes one or more executable instructions for implementing specified logical functions. It should also be noted that in some alternative implementations, functions marked in the blocks may also occur in an order different from that marked in the accompanying drawings. For example, two consecutively-shown blocks may actually be executed in parallel basically, but sometimes may also be executed in a reverse order, which depends on involved functions. It should be further noted that each block in the block diagrams and/or flowcharts, as well as a combination of the blocks in the block diagrams and/or flowcharts may be implemented by using a dedicated hardware-based system that executes specified functions or operations, or using a combination of special hardware and computer instructions.

The involved modules described in the embodiments of the disclosure may be implemented through software or hardware. The name of the module does not limit the module in certain cases. For example, the first processing module may be described as a “first slicing module”.

The functions described above in this specification may be at least partially executed by one or more hardware logic components. For example, exemplary hardware logic components that can be used include, but are not limited to, a field-programmable gate array (FPGA), an application specific integrated circuit (ASIC), an application specific standard part (ASSP), a system on chip (SOC), a complex programmable logic device (CPLD), etc.

In the context of the disclosure, a machine-readable medium may be a tangible medium that may contain or store a program, and the program may be used by the instruction execution system, apparatus, or device, or used in conjunction with the instruction execution system, apparatus, or device. The machine-readable medium may be a machine-readable signal medium or a machine-readable storage medium. The machine-readable medium may comprise, but is not limited to: electronic, magnetic, optical, electromagnetic, infrared, or semiconductor systems, apparatuses, or devices, or any proper combination of the above. More specific examples of the machine-readable storage medium may comprise: an electrical connection based on one or more wires, a portable computer disk, a hard drive, a random access memory (RAM), a read-only memory (ROM), an erasable programmable read-only memory (EPROM or a flash memory), fiber optics, a portable compact disc read-only memory (CD-ROM), an optical storage device, a magnetic storage device, or any proper combination of the above content.

According to one or more embodiments of the disclosure, Example 1 provides a caption alignment method for an audio, comprising:
obtaining a target audio and a target caption text of the target audio;
obtaining a plurality of first target audios by slicing the target audio according to a slicing duration in a case that a duration of the target audio is greater than a first preset duration;
determining first audio feature information of each of the first target audios;
obtaining target audio feature information of the target audio by concatenating all of the first audio feature information in a case that the duration of the target audio is less than or equal to a second preset duration, wherein the second preset duration is greater than the first preset duration; and
generating caption information corresponding to the target audio according to the target caption text and the target audio feature information.

According to one or more embodiments of the disclosure, Example 2 provides the method according to Example 1, where the method further includes:
obtaining a plurality of second target audios by merging a plurality of the consecutive first target audios in a case that the duration of the target audio is greater than the second preset duration, wherein a duration of each of the second target audios does not exceed the second preset duration;
obtaining second audio feature information by concatenating, for each of the second target audios, respective first audio feature information in the second target audio;
determining a caption text segment corresponding to the second target audio according to the second audio feature information and the target caption text;
determining alignment information of each frame of audio in each of the second target audios according to the second audio feature information and the caption text segment, wherein the alignment information comprises the frame of audio and characters in the target caption text matching the frame of audio; and
generating caption information corresponding to the target audio by concatenating the alignment information of each of the second target audios.

According to one or more embodiments of the disclosure, Example 3 provides the method according to Example 2, where the method further comprises:
determining whether a missing text exists by comparing a concatenated caption text in the caption information with the target caption text;
determining a first caption text segment and a second caption text segment adjacent to the missing text according to the target caption text in a case that the missing text exists, wherein time information corresponding to the first caption text segment is earlier than time information corresponding to the second caption text segment;
determining a text insertion time based on a last moment in the alignment information corresponding to the first caption text segment and an earliest moment in the alignment information corresponding to the second caption text segment; and
obtaining updated caption information by inserting the missing text into the concatenated caption text within the text insertion time.

According to one or more embodiments of the disclosure, Example 4 provides the method according to Example 2, where after generating caption information corresponding to the target audio by concatenating the alignment information of each of the second target audios, the method further comprises:
determining a confidence of a repeated text in the adjacent second target audios respectively in a case that determine, based on the target caption text, that the repeated text exists in the alignment information corresponding to the adjacent second target audios; and
obtaining updated caption information by removing the repeated text in the alignment information of the second target audio with a low confidence from the adjacent second target audios.

According to one or more embodiments of the disclosure, Example 5 provides the method according to Example 4, where determining a confidence of the repeated text in the adjacent second target audios respectively comprises:
determining a matching confidence of each character of the repeated text in the two adjacent second target audios respectively; and
determining a confidence of the repeated text in the second target audio according to the matching confidence of each of the characters in the second target audio.

According to one or more embodiments of the disclosure, Example 6 provides the method according to Example 1, where the determining first fragment of audio feature information of each of the first target audios comprises:
obtaining audio feature information of the first target audio by inputting the first target audio into a pre-trained feature extraction model, wherein the feature extraction model is an encoder in a model trained based on a sample audio and a text corresponding to the sample audio.

According to one or more embodiments of the disclosure, Example 7 provides the method according to Example 1, where the generating caption information corresponding to the target audio according to the target caption text and the target audio feature information comprises: determining alignment information of each frame of audio in the target audio according to the target caption text and the target audio feature information, wherein the alignment information comprises the frame of audio and characters in the target caption text matching the frame of audio; and
generating caption information corresponding to the target audio according to the alignment information and frame length of each frame of audio.

According to one or more embodiments of the disclosure, Example 8 provides a caption alignment apparatus for an audio, comprising:
an obtaining module, configured to obtain a target audio and a target caption text of the target audio;
a first processing module, configured to obtain a plurality of first target audios by slicing the target audio according to a slicing duration in a case that a duration of the target audio is greater than a first preset duration;
a first determining module, configured to determine first audio feature information of each of the first target audios;
a second processing module, configured to obtain target audio feature information of the target audio by concatenating all of the first audio feature information in a case that the duration of the target audio is less than or equal to a second preset duration, wherein the second preset duration is greater than the first preset duration; and
a first generation module, configured to generate caption information corresponding to the target audio according to the target caption text and the target audio feature information.

According to one or more embodiments of the disclosure, Example 9 provides the apparatus according to Example 8, where the apparatus further comprises:
a third processing module, configured to obtain a plurality of second target audios by merging a plurality of the consecutive first target audios in a case that the duration of the target audio is greater than the second preset duration, wherein a duration of each of the second target audios does not exceed the second preset duration;
a fourth processing module, configured to obtain second audio feature information by concatenating, for each of the second target audios, respective first audio feature information in the second target audio;
a second determining module, configured to determine a caption text segment corresponding to the second target audio according to the second audio feature information and the target caption text;
a third determining module, configured to determine alignment information of each frame of audio in each of the second target audios according to the second audio feature information and the caption text segment, wherein the alignment information comprises the frame of audio and characters in the target caption text matching the frame of audio; and
a second generation module, configured to generate caption information corresponding to the target audio by concatenating the alignment information of each of the second target audios.

According to one or more embodiments of the disclosure, Example 10 provides the apparatus according to Example 9, where the apparatus further comprises:
a comparison module, configured to determine whether a missing text exists by comparing a concatenated caption text in the caption information with the target caption text;
a fourth determining module, configured to determine a first caption text segment and a second caption text segment adjacent to the missing text according to the target caption text in a case that the missing text exists, wherein time information corresponding to the first caption text segment is earlier than time information corresponding to the second caption text segment;
a fifth determining module, configured to determine a text insertion time based on a last moment in the alignment information corresponding to the first caption text segment and an earliest moment in the alignment information corresponding to the second caption text segment; and
a first update module, configured to obtain updated caption information by inserting the missing text into the concatenated caption text within the text insertion time.

According to one or more embodiments of the disclosure, Example 11 provides the apparatus according to Example 9, where the apparatus further comprises:
a sixth determining module, configured to determine a confidence of a repeated text in the adjacent second target audios respectively in a case that determine, based on the target caption text, that the repeated text exists in the alignment information corresponding to the adjacent second target audios; and
a second update module, configured to obtain updated caption information by removing the repeated text in the alignment information of the second target audio with a low confidence from the adjacent second target audios.

According to one or more embodiments of the disclosure, Example 12 provides the apparatus according to Example 11, where the sixth determining module is configured to respectively determine confidence of the repeated text in the adjacent second target audios by:
determining a matching confidence of each character of the repeated text in the two adjacent second target audios respectively; and
determining a confidence of the repeated text in the second target audio according to the matching confidence of each of the characters in the second target audio.

According to one or more embodiments of the disclosure, Example 13 provides the apparatus according to Example 8, where the first determining module is configured to determine first segment of audio feature information of each of the first target audios by:
obtaining audio feature information of the first target audio by inputting the first target audio into a pre-trained feature extraction model, wherein the feature extraction model is an encoder in a model trained based on a sample audio and a text corresponding to the sample audio.

According to one or more embodiments of the disclosure, Example 14 provides the apparatus according to Example 8, where the second processing module comprises:
a first determining submodule, configured to determine alignment information of each frame of audio in the target audio according to the target caption text and the target audio feature information, wherein the alignment information comprises the frame of audio and characters in the target caption text matching the frame of audio; and
a generation submodule, configured to generate caption information corresponding to the target audio according to the alignment information and frame length of each frame of audio.

According to one or more embodiments of the disclosure, Example 15 provides a computer-readable medium, having a computer program stored thereon, where the program, when executed by a processing means, implements the steps of the method according to any one of Examples 1 to 7.

According to one or more embodiments of the disclosure, Example 16 provides an electronic device, including: a storage means, having a computer program stored thereon; and a processing means, configured to execute the computer program in the storage means so as to implement the steps of the method according to any one of Examples 1 to 7.

The above descriptions are merely preferred embodiments of the disclosure and explanations of the applied technical principles. Those skilled in the art should understand that the scope of open in the disclosure is not limited to the technical solutions formed by specific combinations of the above technical features, and also covers other technical solutions formed by arbitrary combinations of the above technical features or equivalent features without departing from the concept of the disclosure, such as a technical solution formed by replacing the above features with the technical features with similar functions disclosed (but not limited to) in the disclosure.

Further, although the operations are described in a particular order, it should not be understood as requiring these operations to be performed in the shown particular order or in a sequential order. In certain environments, multitasking and parallel processing may be advantageous. Similarly, although several specific implementation details are included in the above discussion, these specific implementation details should not be interpreted as limitations on the scope of the disclosure. Certain features described in the context of separate embodiments may also be implemented in combination in a single embodiment. Conversely, various features described in the context of a single embodiment may also be implemented separately or in any suitable sub-combination in a plurality of embodiments.

Although the subject has been described by adopting language specific to structural features and/or method logical actions, it should be understood that the subject limited in the appended claims is not necessarily limited to the specific features or actions described above. On the contrary, the specific features and actions described above are merely example forms for implementing the claims. Regarding the apparatus in the above embodiments, the specific method in which each module performs operations has been described in detail in the embodiments related to the method, which will not be set forth in detail here.

I/We claim:

1. A caption alignment method for an audio, comprising:
obtaining a target audio and a target caption text of the target audio;
obtaining a plurality of first target audios by slicing the target audio according to a slicing duration in a case that a duration of the target audio is greater than a first preset duration;
determining first audio feature information of each of the first target audios;
obtaining target audio feature information of the target audio by concatenating all of the first audio feature information in a case that the duration of the target audio is less than or equal to a second preset duration, wherein the second preset duration is greater than the first preset duration; and
generating caption information corresponding to the target audio according to the target caption text and the target audio feature information.

2. The method according to claim 1, wherein the method further comprises:
obtaining a plurality of second target audios by merging a plurality of the consecutive first target audios in a case that the duration of the target audio is greater than the second preset duration, wherein a duration of each of the second target audios does not exceed the second preset duration;
obtaining second audio feature information by concatenating, for each of the second target audios, respective first audio feature information in the second target audio;
determining a caption text segment corresponding to the second target audio according to the second audio feature information and the target caption text;
determining alignment information of each frame of audio in each of the second target audios according to the second audio feature information and the caption text segment, wherein the alignment information comprises the frame of audio and characters in the target caption text matching the frame of audio; and
generating caption information corresponding to the target audio by concatenating the alignment information of each of the second target audios.

3. The method according to claim 2, wherein after generating the caption information corresponding to the target audio by concatenating the alignment information of each of the second target audios, the method further comprises:
determining whether a missing text exists by comparing a concatenated caption text in the caption information with the target caption text;
determining a first caption text segment and a second caption text segment adjacent to the missing text according to the target caption text in a case that the missing text exists, wherein time information corresponding to the first caption text segment is earlier than time information corresponding to the second caption text segment;
determining a text insertion time based on a last moment in the alignment information corresponding to the first caption text segment and an earliest moment in the alignment information corresponding to the second caption text segment; and
obtaining updated caption information by inserting the missing text into the concatenated caption text within the text insertion time.

4. The method according to claim 2, wherein after generating the caption information corresponding to the target audio by concatenating the alignment information of each of the second target audios, the method further comprises:
determining a confidence of a repeated text in the adjacent second target audios respectively in a case that it is determined, based on the target caption text, that the repeated text exists in the alignment information corresponding to the adjacent second target audios; and
obtaining updated caption information by deleting the repeated text in the alignment information of the second target audio with a low confidence from the adjacent second target audios.

5. The method according to claim 4, wherein determining the confidence of the repeated text in the adjacent second target audios respectively comprises:
determining a matching confidence of each character of the repeated text in the two adjacent second target audios respectively; and
determining a confidence of the repeated text in the second target audio according to the matching confidence of each of the characters in the second target audio.

6. The method according to claim 1, wherein determining the first fragment of audio feature information of each of the first target audios comprises:
obtaining audio feature information of the first target audio by inputting the first target audio into a pre-trained feature extraction model, wherein the feature extraction model is an encoder in a model trained based on a sample audio and a text corresponding to the sample audio.

7. The method according to claim 1, wherein generating the caption information corresponding to the target audio according to the target caption text and the target audio feature information comprises:
determining alignment information of each frame of audio in the target audio according to the target caption text and the target audio feature information, wherein the alignment information comprises the frame of audio and characters in the target caption text matching the frame of audio; and
generating the caption information corresponding to the target audio according to the alignment information and frame length of each frame of audio.

8. A non-transitory computer-readable medium, having a computer program stored thereon, wherein the program, when executed by a processing means, causes the processing means to:
obtain a target audio and a target caption text of the target audio;
obtain a plurality of first target audios by slicing the target audio according to a slicing duration in a case that a duration of the target audio is greater than a first preset duration;
determine first audio feature information of each of the first target audios;
obtain target audio feature information of the target audio by concatenating all of the first audio feature information in a case that the duration of the target audio is less than or equal to a second preset duration, wherein the second preset duration is greater than the first preset duration; and
generate caption information corresponding to the target audio according to the target caption text and the target audio feature information.

9. The medium according to claim 8, wherein the program further causes the processing means to:
obtain a plurality of second target audios by merging a plurality of the consecutive first target audios in a case that the duration of the target audio is greater than the second preset duration, wherein a duration of each of the second target audios does not exceed the second preset duration;
obtain second audio feature information by concatenating, for each of the second target audios, respective first audio feature information in the second target audio;
determine a caption text segment corresponding to the second target audio according to the second audio feature information and the target caption text;
determine alignment information of each frame of audio in each of the second target audios according to the second audio feature information and the caption text segment, wherein the alignment information comprises the frame of audio and characters in the target caption text matching the frame of audio; and
generating caption information corresponding to the target audio by concatenating the alignment information of each of the second target audios.

10. The medium according to claim 9, wherein after generating the caption information corresponding to the target audio by concatenating the alignment information of each of the second target audios, the program further causes the processing means to:
determine whether a missing text exists by comparing a concatenated caption text in the caption information with the target caption text;
determine a first caption text segment and a second caption text segment adjacent to the missing text according to the target caption text in a case that the missing text exists, wherein time information corresponding to the first caption text segment is earlier than time information corresponding to the second caption text segment;
determine a text insertion time based on a last moment in the alignment information corresponding to the first caption text segment and an earliest moment in the alignment information corresponding to the second caption text segment; and
obtain updated caption information by inserting the missing text into the concatenated caption text within the text insertion time.

11. The medium according to claim 9, wherein after generating the caption information corresponding to the target audio by concatenating the alignment information of each of the second target audios, the program further causes the processing means to:
determine a confidence of a repeated text in the adjacent second target audios respectively in a case that it is determined, based on the target caption text, that the repeated text exists in the alignment information corresponding to the adjacent second target audios; and
obtain updated caption information by deleting the repeated text in the alignment information of the second target audio with a low confidence from the adjacent second target audios.

12. The medium according to claim 11, wherein the program causing the processing means to determine the confidence of the repeated text in the adjacent second target audios respectively further causes the processing means to:
determine a matching confidence of each character of the repeated text in the two adjacent second target audios respectively; and
determine a confidence of the repeated text in the second target audio according to the matching confidence of each of the characters in the second target audio.

13. The medium according to claim 8, wherein the program causing the processing means to determine the first fragment of audio feature information of each of the first target audios further causes the processing means to:
obtain audio feature information of the first target audio by inputting the first target audio into a pre-trained feature extraction model, wherein the feature extraction model is an encoder in a model trained based on a sample audio and a text corresponding to the sample audio.

14. The medium according to claim 8, wherein the program causing the processing means to generate the caption information corresponding to the target audio according to the target caption text and the target audio feature information further causes the processing means to:
determine alignment information of each frame of audio in the target audio according to the target caption text and the target audio feature information, wherein the alignment information comprises the frame of audio and characters in the target caption text matching the frame of audio; and
generate the caption information corresponding to the target audio according to the alignment information and frame length of each frame of audio.

15. An electronic device, comprising:
a storage means, having at least one computer program stored thereon; and
at least one processing means, wherein the program, when executed by the processing means, causes the processing means to:
obtain a target audio and a target caption text of the target audio;
obtain a plurality of first target audios by slicing the target audio according to a slicing duration in a case that a duration of the target audio is greater than a first preset duration;
determine first audio feature information of each of the first target audios;
obtain target audio feature information of the target audio by concatenating all of the first audio feature information in a case that the duration of the target audio is less than or equal to a second preset duration, wherein the second preset duration is greater than the first preset duration; and
generate caption information corresponding to the target audio according to the target caption text and the target audio feature information.

16. The device according to claim 15, wherein the program further causes the processing means to:
obtain a plurality of second target audios by merging a plurality of the consecutive first target audios in a case that the duration of the target audio is greater than the second preset duration, wherein a duration of each of the second target audios does not exceed the second preset duration;
obtain second audio feature information by concatenating, for each of the second target audios, respective first audio feature information in the second target audio;
determine a caption text segment corresponding to the second target audio according to the second audio feature information and the target caption text;
determine alignment information of each frame of audio in each of the second target audios according to the second audio feature information and the caption text segment, wherein the alignment information comprises the frame of audio and characters in the target caption text matching the frame of audio; and
generating caption information corresponding to the target audio by concatenating the alignment information of each of the second target audios.

17. The device according to claim 16, wherein after generating the caption information corresponding to the target audio by concatenating the alignment information of each of the second target audios, the program further causes the processing means to:
determine whether a missing text exists by comparing a concatenated caption text in the caption information with the target caption text;
determine a first caption text segment and a second caption text segment adjacent to the missing text according to the target caption text in a case that the missing text exists, wherein time information corresponding to the first caption text segment is earlier than time information corresponding to the second caption text segment;
determine a text insertion time based on a last moment in the alignment information corresponding to the first caption text segment and an earliest moment in the alignment information corresponding to the second caption text segment; and
obtain updated caption information by inserting the missing text into the concatenated caption text within the text insertion time.

18. The device according to claim 17, wherein after generating the caption information corresponding to the target audio by concatenating the alignment information of each of the second target audios, the program further causes the processing means to:
determine a confidence of a repeated text in the adjacent second target audios respectively in a case that it is determined, based on the target caption text, that the repeated text exists in the alignment information corresponding to the adjacent second target audios; and
obtain updated caption information by deleting the repeated text in the alignment information of the second target audio with a low confidence from the adjacent second target audios.

19. The device according to claim 18, wherein the program causing the processing means to determine the confidence of the repeated text in the adjacent second target audios respectively further causes the processing means to:
determine a matching confidence of each character of the repeated text in the two adjacent second target audios respectively; and
determine a confidence of the repeated text in the second target audio according to the matching confidence of each of the characters in the second target audio.

20. The device according to claim 15, wherein the program causing the processing means to determine the first fragment of audio feature information of each of the first target audios further causes the processing means to:
obtain audio feature information of the first target audio by inputting the first target audio into a pre-trained feature extraction model, wherein the feature extraction model is an encoder in a model trained based on a sample audio and a text corresponding to the sample audio.
